(19) United States
(12) Patent Application Publication
(10) Pub. No.: US 2025/0278682 A1
(43) Pub. Date: Sep. 4, 2025

(54) REAL-TIME TICKET MANAGEMENT

(71) Applicant: Kyndryl, Inc., New York, NY (US)

(72) Inventors: Mouleswara Reddy Chintakunta, Allagadda (IN); Keri Wheatley, Sevierville, TN (US); Shahid Rashid, Srinagar (IN)

(21) Appl. No.: 18/591,762

(22) Filed: Feb. 29, 2024

(51) Int. Cl. G06Q 10/0631; G06F 18/2413

(52) U.S. Cl. CPC G06Q 10/06312; G06F 18/24147

(57) ABSTRACT

Embodiments receive ticket input data, determine an estimated resolution time using at least one machine learning (ML) model based on the received ticket input data, determine a ticket mis-assignment data based on the received ticket input data, and send a ticket output data based on the estimated resolution time and the ticket mis-assignment data.

### BACKGROUND

Aspects of the present invention relate generally to real-time ticket management and, more particularly, to systems and methods of real-time ticket management using a dynamic lifecycle generator and a ticket duration reducer.

Service tickets are often reassigned many times before they are resolved. Reassignments can be the result of, for example, being assigned incorrectly the first time, being re-assigned by an agent/department, or by consultations between multiple teams to fully resolve issues.

### SUMMARY

In a first aspect of the invention, there is a computer-implemented method including: receiving, by a computing device, ticket input data; determining, by the computing device, an estimated resolution time using at least one machine learning (ML) model based on the received ticket input data; determining, by the computing device, a ticket mis-assignment data based on the received ticket input data; and sending, by the computing device, a ticket output data based on the estimated resolution time and the ticket mis-assignment data.

In another aspect of the invention, there is a computer program product including one or more computer readable storage media having program instructions collectively stored on the one or more computer readable storage media. The program instructions are executable to: receive ticket input data; determine an estimated resolution time using at least one machine learning (ML) model based on the received ticket input data; determine a ticket mis-assignment data based on the received ticket input data; send a ticket output data based on the estimated resolution time and the ticket mis-assignment data; and identify at least one culprit for the ticket mis-assignment data.

In another aspect of the invention, there is a system including a processor, a computer readable memory, one or more computer readable storage media, and program instructions collectively stored on the one or more computer readable storage media. The program instructions are executable to: receive ticket input data; predict bandwidth hours by a department and an agent based on the received ticket input data; determine an estimated resolution time using at least one machine learning (ML) model based on the received ticket input data and the predicted bandwidth hours; determine a ticket mis-assignment data based on the received ticket input data; and send a ticket output data based on the estimated resolution time and the ticket mis-assignment data.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of a ticket management system in accordance with aspects of the present invention.

FIG. 5 shows a block diagram of a dynamic lifecycle generator in accordance with aspects of the present invention.

FIG. 6 shows a block diagram of a lifecycle generator module in accordance with aspects of the present invention.

FIG. 7 shows a block diagram of an agent hierarchical bandwidth predictor and a resolution estimator module in accordance with aspects of the present invention.

FIG. 8 shows a block diagram of a ticket duration reducer module in accordance with aspects of the present invention.

FIG. 9 shows an example of the ticket duration reducer module modeling a network in accordance with aspects of the present invention.

FIG. 10 shows an example of a table of actions of the ticket duration reducer module modeling the network in accordance with aspects of the present invention.

FIG. 11 shows a table for a regression model of the ticket duration reducer module in accordance with aspects of the present invention.

FIG. 12 shows a flowchart of an exemplary method in accordance with aspects of the present invention.

### DETAILED DESCRIPTION

Aspects of the present invention relate generally to real-time ticket management and, more particularly, to systems and methods of real-time ticket management using a dynamic lifecycle generator and a ticket duration reducer. Aspects of the present invention prevent costly downtime and mis-assignment of tickets by managing incident information. In particular, embodiments of the present invention provide a way to keep track of important incident information, such as a timeline of resolution of the incident information, who was involved in resolving the incident information, a duration of the resolution of the incident information, etc., in order to avoid costly downtime and mis-assignment of tickets. Aspects of the present invention also improve customer service by maintaining an efficient workflow assignment and monitoring system which avoids a time delay between departments. Embodiments of the present invention also identify a root cause of re-assignments with dynamic lifecycle generation for each incident, which provides departments advanced awareness about future assignments.

For example, aspects of the present invention provide a system and a method for creating a dynamic lifecycle generator which identifies departments to assign tickets and determines a ticket resolution lifecycle. The system and method can generate a lifecycle for a given ticket based on historical ticket assignments, in addition to predicting ticket resolution times based on historical ticket lifecycles, ticket complexity, a future agent who will work on ticket resolution, and/or department bandwidth. In this manner, the system and method decreases an overall open duration in ticketing management workflows.

Embodiments of the present invention also provide a system and a method for identifying and determining personnel who are responsible for ticket workflow delays. The system and a method also extract features from a network graph to model mis-assignment issues. For example, the system and method generates labeled data for mis-assignment issues using network graphs and other attributes. In further embodiments of the present invention, the labeled data may be used for training a regression model.

According to an aspect of the invention, the computer-implemented method includes: identifying a plurality of departments for ticket assignment, determining a ticket resolution lifecycle, generating a lifecycle for a ticket based on historical ticket assignments, and predicting ticket resolution times based on historical ticket lifecycles, ticket complexity, and future agent or department bandwidth. In this way, embodiments of the present invention, amongst other things, can: avoid costly downtime and mis-assignments by giving users an easier way to manage incidents; keep track of important incident information, such as timeline, who was involved, duration; and identify the root cause of reassignments with dynamic lifecycle generation for each incident, giving departments advanced awareness about future assignments. Accordingly, aspects of the present invention provide a significant improvement of business processes for a call center and a service desk help center. Thus, implementations of the present invention improve an overall customer service by maintaining an efficient workflow assignment and monitoring system which avoids timely delays.

Accordingly, implementations of the present invention provide an improvement in the technical field of workflow management by identifying root causes of service ticket reassignments. In further embodiments, embodiments of the present invention identify problem agents and/or departments and identify systematic errors in ticket assignments. Further, aspects of the present invention track progress in decreasing ticket reassignments and ticket duration. In contrast, known systems reassign service tickets many times before a final resolution, which can cause costly delays in resolution and utilization of additional resources. In particular, known systems simply use basic reports to determine the root cause of ticket assignments, which are difficult to identify and are often inaccurate. Accordingly, unlike embodiments of the present invention, known systems and methods cannot, for example: identify the root cause of service ticket reassignments due to, for example, incorrect assignments, difficult/complicated tickets, etc.; identify problem agents/departments; identify systematic errors in original ticket assignments (e.g., classification model needs to be retrained because of data drift, new areas, etc.); and track positive progress in decreasing ticket reassignments and ticket duration.

Implementations of the present invention are thus necessarily rooted in computer technology. For example, the steps of training a plurality of machine learning models to determine a severity of a ticket, identify and classify components of the ticket, provide a resolution estimate and a lifecycle order based on historical tickets, and forecast bandwidth needs are computer-based and cannot be performed in the human mind. Training and building the plurality of machine learning models is, by definition, performed by a computer and cannot practically be performed in the human mind (or with pen and paper) due to the complexity and massive amounts of calculations involved. Given the scale and complexity of determining the severity of the ticket, identifying and classifying components of the ticket, providing the resolution estimate and the lifecycle order based on historical tickets, and forecasting bandwidth needs, it is simply not possible for the human mind, or for a person using pen and paper, to perform the number of calculations invoiced in training and/or building the plurality of machine learning models in real-time.

It should be understood that, to the extent implementations of the invention collect, store, or employ personal information provided by, or obtained from, individuals (for example, users associated with service tickets), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

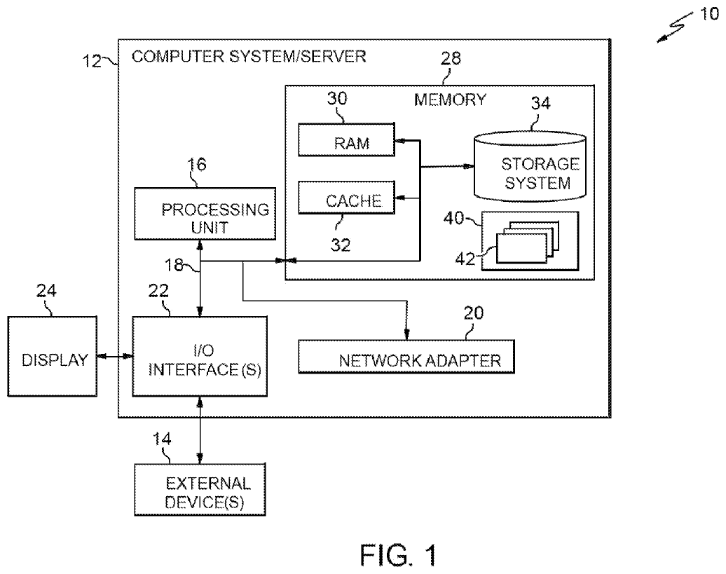

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

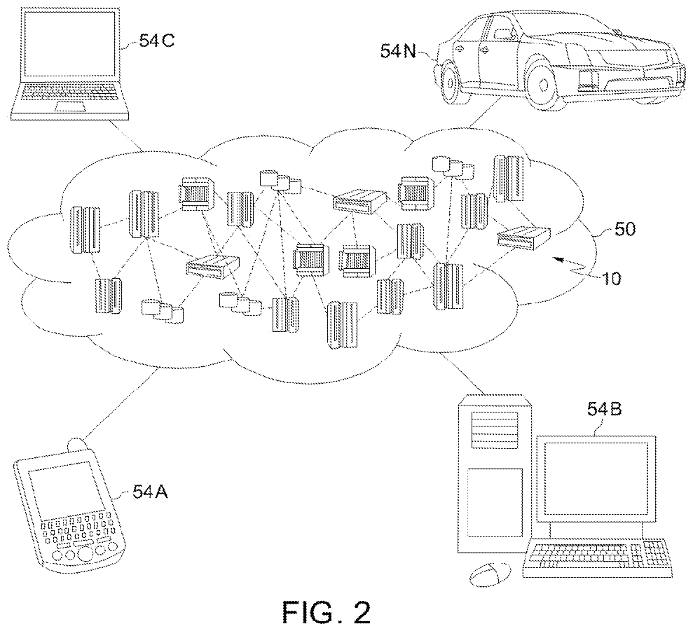

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

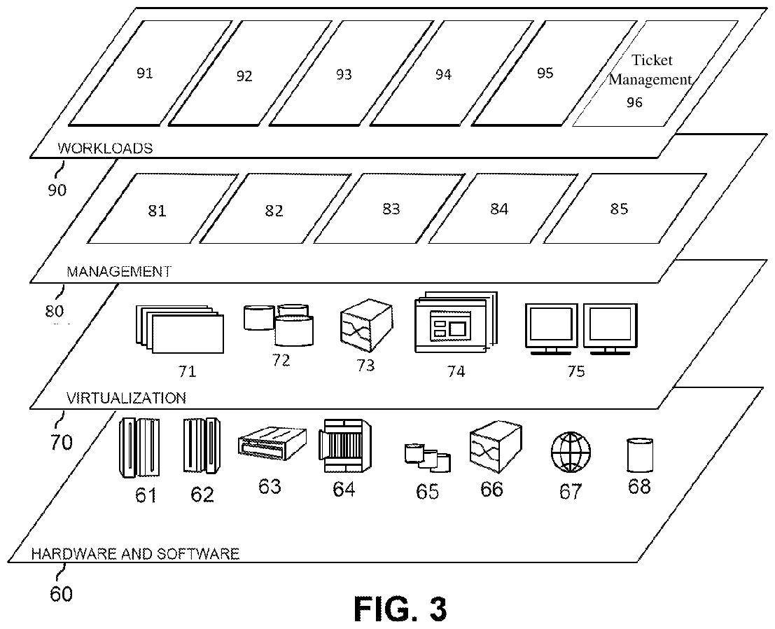

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and ticket management 96.

Implementations of the invention may include a computer system/server 12 of FIG. 1 in which one or more of the program modules 42 are configured to perform (or cause the computer system/server 12 to perform) one of more functions of the ticket management 96 of FIG. 3. For example, the one or more of the program modules 42 of the ticket management 96 may be configured to: receive ticket input data; determine an estimated resolution time using at least one machine learning (ML) model based on the received ticket input data; determine a ticket mis-assignment data based on the received ticket input data; and send a ticket output data based on the estimated resolution time and the ticket mis-assignment data.

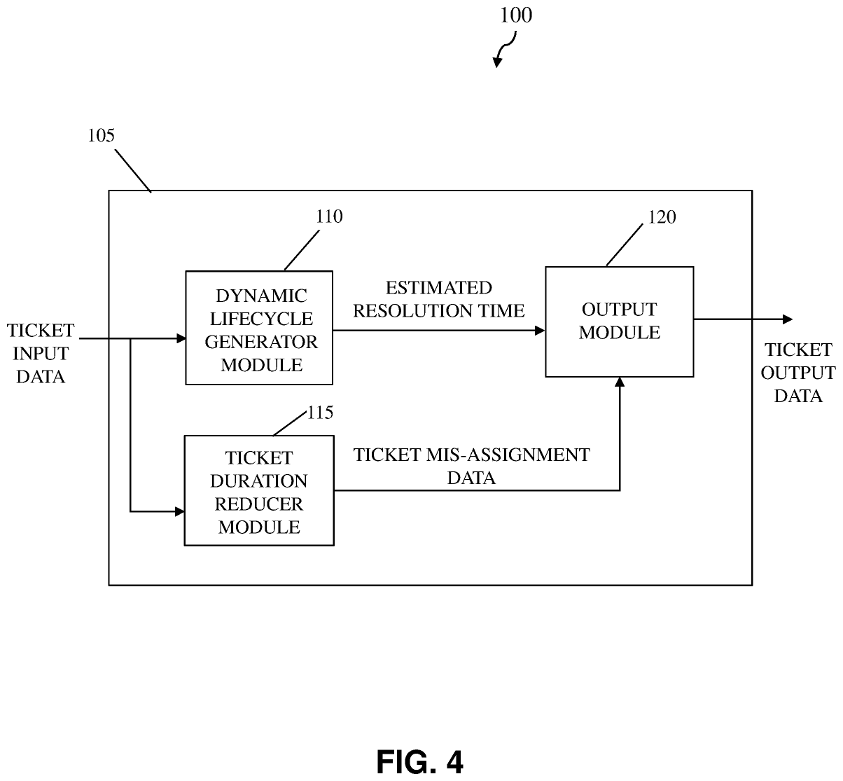

FIG. 4 shows a block diagram of a ticket management system in accordance with aspects of the invention. In embodiments, the ticket management system 100 comprises a ticket management environment 105 which includes a dynamic lifecycle generator module 110, a ticket duration reducer module 115, and an output module 120, each of which may comprise one or more program modules such as program modules 42 described with respect to FIG. 1 and the ticket management 96.

The ticket management system 100 may include additional or fewer modules than those shown in FIG. 4. In embodiments, separate modules may be integrated into a single module. Additionally, or alternatively, a single module may be implemented as multiple modules. Moreover, the quantity of devices and/or networks in the environment is not limited to what is shown in FIG. 4. In practice, the environment may include additional devices and/or networks; fewer devices and/or networks; different devices and/or networks; or differently arranged devices and/or networks than illustrated in FIG. 4.

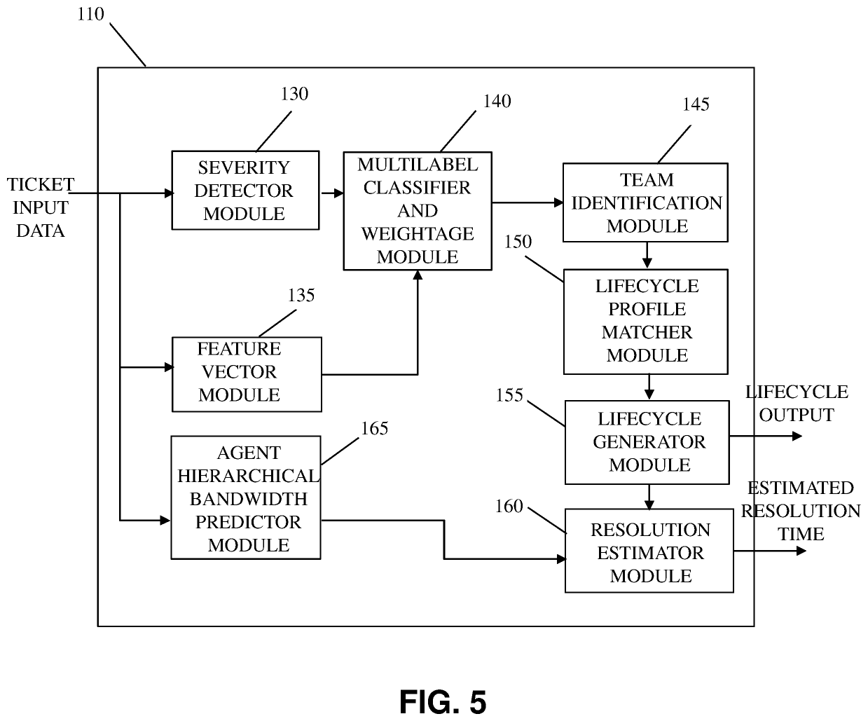

In embodiments of FIG. 4, the dynamic lifecycle generator module 110 receives ticket input data corresponding to at least one current ticket and outputs an estimated resolution time to an output module 120. In an example, ticket input data comprises a helpdesk agent service ticket, an application ticket, a website ticket, a customer retail support ticket, an airline support ticket, a finance ticket, and/or a human resources ticket, amongst other examples. In embodiments, the dynamic lifecycle generator module 110 creates a ticket profile in real-time based on a severity of a ticket, a content of the ticket, an owner of the ticket, an assignment of the ticket, etc. In aspects of the present invention, the dynamic lifecycle generator module 110 generates a ticket lifecycle with a plurality of downstream department predictions in real-time. For example, the downstream department predictions comprise a team working on a data science (DS) component of the ticket, a team working on a user interface (UI) component of the ticket, and/or a team working on a quality assurance (QU) component of the ticket, etc. In further embodiments, the dynamic lifecycle generator module 110 generates duration predictions for each assignment within the ticket lifecycle in real-time. For example, the dynamic lifecycle generator module 110 generates the duration predictions for each assignment within the ticket lifecycle based on determining bottleneck areas based on a generated report, such as quality assurance or ticket analysis or a priority mismatch between agents and/or departments. In further embodiments, the dynamic lifecycle generator module 110 provides profile characteristics, such as a duration of high priority items and medium priority items. Details of the dynamic lifecycle generator module 110 are described further with respect to FIG. 5.

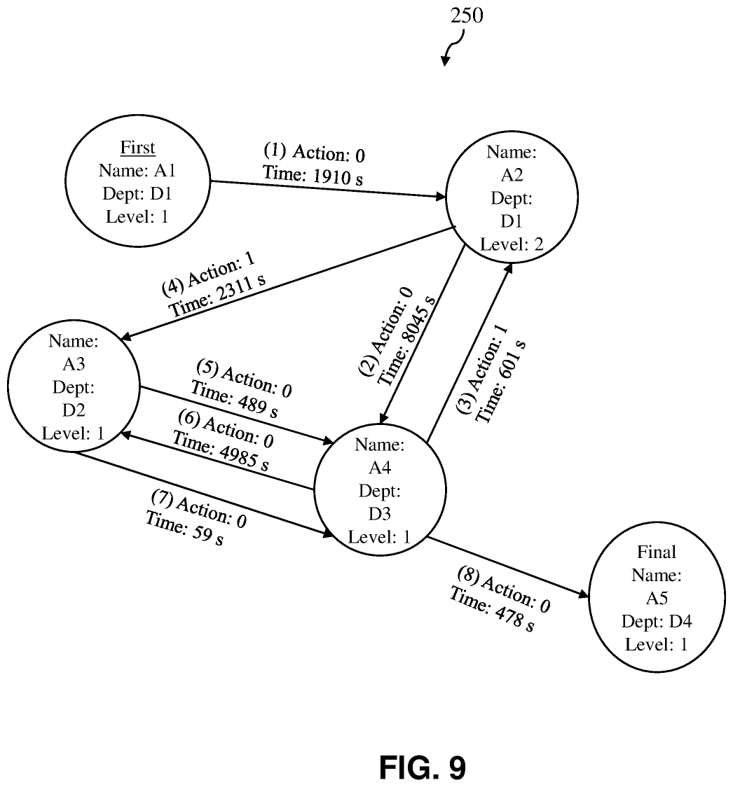

In FIG. 4, the ticket duration reducer module 115 receives the ticket input data and outputs ticket mis-assignment data to the output module 120. The ticket duration reducer module 115 automatically assigns an initial agent to the ticket in real-time, as well as re-assigns any mis-assigned tickets in real-time. For example, the ticket duration reducer module 115 automatically assigns a department change to a last agent contact within the department in real-time. In further embodiments, the ticket duration reducer module 115 provides a real-time alert on any issue with a ticket, such as a stale ticket, an agent that is scheduled to handle a ticket being on vacation, an agent leaving a department, etc. Moreover, in aspects of the present invention, the ticket duration reducer module 115 identifies culprits for ticket mis-assignments, in addition to identifying the culprits for employees and departments with regards to stale tickets. In embodiments, the ticket duration reducer module 115 provides a report on agent response times across a system history and, in embodiments, provides an alert on data drift for an assignment classification model. Details of the ticket duration reducer module 115 are described herein with respect to FIGS. 9-11.

Still referring to FIG. 4, the output module 120 receives the estimated resolution time from the dynamic lifecycle generator module 110 and the ticket mis-assignment data from the ticket duration reducer module 115 and outputs this data as a ticket output data to an external system. For example, the output module 120 may output the ticket output data including the estimated resolution time and the ticket mis-assignment data to an external system which tracks ticket metrics and identifies root causes of ticket mismanagement.

FIG. 5 shows a block diagram of a dynamic lifecycle generator module 110 in accordance with aspects of the present invention. In embodiments, the dynamic lifecycle generator module 110 comprises a severity detector module 130, a feature vector module 135, a multilabel classifier and weightage module 140, a team identification module 145, a lifecycle profile matcher module 150, a lifecycle generator module 155, a resolution estimator module 160, and an agent hierarchical bandwidth predictor module 165.

In FIG. 5, the severity detector module 130 receives the ticket input data and automatically determines a severity of each ticket. In embodiments, the severity detector module 130 determines the severity of each ticket using natural language processing (NLP) and/or machine learning (ML). In particular, the severity detector module 130 determines the severity of each ticket by training and building a model by utilizing at least one ML algorithm, such as extreme gradient boosting (XGBoost), random forest, and support vector machine (SVM). In embodiments, the severity detector module 130 determines whether each ticket has a low severity, a medium severity, or a high severity based on the NLP or ML. The severity detector module 130 sends the severity of each ticket to the multilabel classifier and weightage module 140.

In FIG. 5, the feature vector module 135 receives the ticket input data and extracts feature vectors from the ticket input data and sends the feature vectors to the multilabel classifier and weightage module 140. The multilabel classifier and weightage module 140 receives the features vectors and the severity of each ticket and identifies ticket components using a multilabel classifier model and corresponding weightage of each ticket component. In particular, the multilabel classifier and weightage module 140 identifies ticket components by training and building the multilabel classifier model using deep learning with an artificial neural network (ANN). The multilabel classifier and weightage module 140 sends the identified ticket components and the corresponding weightage to the team identification module 145.

Still referring to FIG. 5, the team identification module 145 receives the identified ticket components and the corresponding weightage and identifies at least one team that needs to work on the identified ticket components. For example, the team identification module 145 identifies at least one team that needs to work on the identified ticket components, such as a data science (DS) component, a quality assurance (QA) component, a user interface (UI) component, an integration component, and a cost and affect management (CAM) component. The team identification module 145 sends the identified at least one team, the identified ticket components, and the corresponding weightage for each ticket component to the lifecycle profile matcher module 150.

In FIG. 5, the lifecycle profile matcher module 150 receives the identified at least one team, the identified ticket components, and the corresponding weightage for each ticket component and identifies similar profiles using a similarity matrix model for historical tickets. In particular, the lifecycle profile matcher module 150 identifies the similar profiles using the similarity matrix model for historical tickets which are similar in terms of labels and ticket details to the identified ticket components and the corresponding weightage for each ticket component. Further, the lifecycle profile matcher module 150 identifies the similar profiles by training and building the similarity matrix model using at least one ML algorithm, such as a K-nearest neighbors (KNN) algorithm with co-sine similarity and a linear regression algorithm with co-sine similarity, etc. However, embodiments are not limited to these examples such that the KNN and linear regression algorithms can utilize other similarity metrics, such as Euclidean distance, Manhattan distance, Jaccard similarity, and Pearson correlation coefficient. In further embodiments, the lifecycle profile matcher module 150 identifies the similar profiles by using NLP. The lifecycle profile matcher module 150 sends the similar profiles, the identified ticket components, and the corresponding weightage for each ticket to the lifecycle generator module 155.

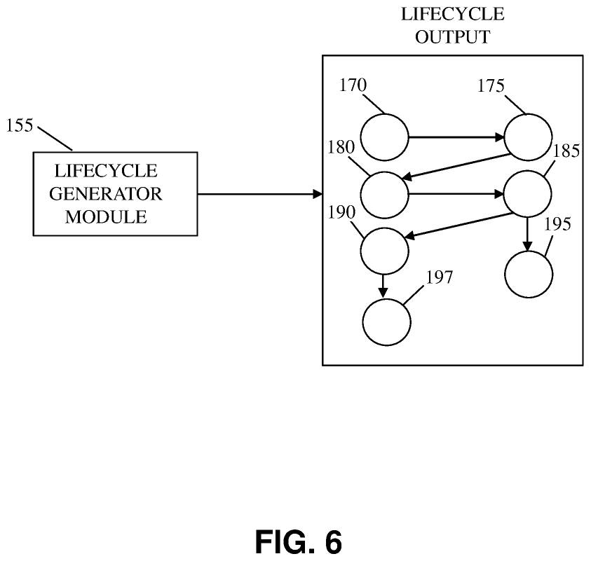

In FIG. 5, the lifecycle generator module 155 receives the similar profiles, the identified ticket components, and the corresponding weightage for each ticket and generates a lifecycle output for the identified ticket components for a current ticket. In particular, the lifecycle generator module 155 generates the lifecycle output by identifying similar lifecycles using a lifecycle model for historical lifecycles which are similar to the identified ticket components and the corresponding weightage for each ticket component. Further, the lifecycle generator module 155 identifies the similar lifecycles by training and building the lifecycle model using at least one ML algorithm, such as a K-nearest neighbors (KNN) algorithm with co-sine similarity and a linear regression algorithm with co-sine similarity, etc. However, embodiments are not limited to these examples such that the KNN and linear regression algorithms can utilize other similarity metrics, such as Euclidean distance, Manhattan distance, Jaccard similarity, and Pearson correlation coefficient. In further embodiments, the lifecycle generator module 155 identifies the similar profiles by using NLP. Details of the lifecycle generator module 155 are described herein with respect to FIG. 6. The lifecycle generator module 155 sends the similar lifecycles, the similar profiles, the identified ticket components, and the corresponding weightage for each ticket to the resolution estimator module 160.

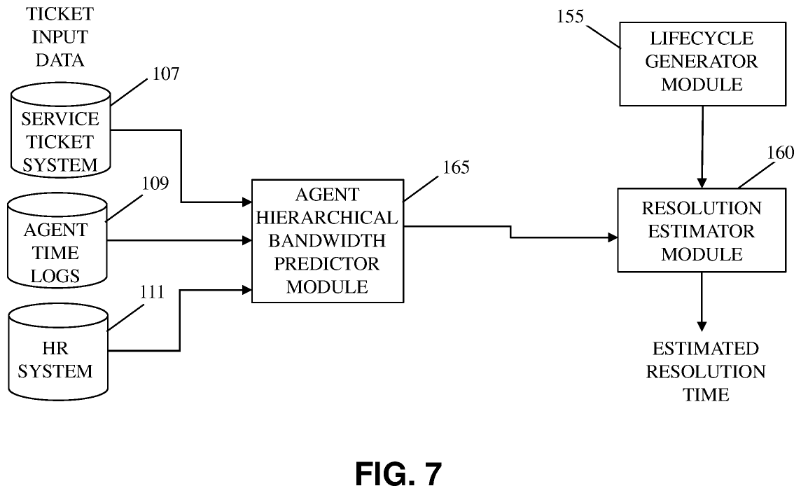

Still referring to FIG. 5, the agent hierarchical bandwidth predictor module 165 receives the ticket input data and predicts bandwidth hours by a department and an agent. In particular, the agent hierarchical bandwidth predictor module 165 predicts the bandwidth hours by using a forecasting model which receives the ticket input data, including ticket details, agent time logs, and human resource (HR) system logs. Further, the agent hierarchical bandwidth predictor module 165 predicts the bandwidth hours by training and building the forecasting model using at least one ML algorithm, such as deep learning with artificial neural network (ANN), long term-short term memory (LSTM) algorithm, recurrent neural network (RNN), etc. In further embodiments, the agent hierarchical bandwidth predictor module 165 predicts the bandwidth hours by using NLP. Details of the agent hierarchical bandwidth predictor module 165 are described herein with respect to FIG. 7. The agent hierarchical bandwidth predictor module 165 sends the predicted bandwidth hours by the department and the agent to the resolution estimator module 160.

In FIG. 5, the resolution estimator module 160 receives the similar lifecycles, the similar profiles, the identified ticket components, the corresponding weightage, and the predicted bandwidth hours by the department and the agent and determines an estimated resolution time of the identified ticket components corresponding to the current ticket. In particular, the resolution estimator module 160 determines the estimated resolution time based on similar profiles and similar lifecycles corresponding to historical tickets. In further embodiments, the estimated resolution time can be expressed in unit times of hours, days, or weeks. As shown in FIG. 4, the estimated resolution time is sent to the output module 120.

FIG. 6 shows a block diagram of a lifecycle generator module 155 in accordance with aspects of the present invention. As shown in FIG. 6, the lifecycle generator module 155 outputs the lifecycle output for the current ticket. In embodiments, the lifecycle output comprises a plurality of sequential components of the current ticket in which the at least one team works on. The lifecycle output for the current ticket may include, for example, the at least one team working on a user interface (UI) component 170 of the current ticket. Then, the lifecycle output for the current ticket includes the at least one team working on a cost and affect management (CAM) component 175 of the current ticket, followed by the at least one team working on an integration component 180 of the current ticket and a data science (DS) component 185 of the current ticket. The lifecycle output for the current ticket then includes the at least one team working on the quality assurance (QA) component 190 of the current ticket and the approval component 195 of the current ticket. The lifecycle output for the current ticket then includes the at least one team working on the fix release component 197 of the current ticket after the QA component 190 of the current ticket.

FIG. 7 shows a block diagram of an agent hierarchical bandwidth predictor module 165 and a resolution estimator module 160 in accordance with aspects of the present invention. In FIG. 7, the agent hierarchical bandwidth predictor module 165 receives the ticket input data which includes a first set of data from a service ticket system 107, a second set of data from agent time logs 109, and a third set of data from a human resource (HR) system 111. For example, the first set of data from the service ticket system 107 includes a ticket duration history by an agent and department, a timeframe after ticket open to assignment to the agent and the department, and a step in ticket assignment workflow. Further, in embodiments, the second set of data from the agent time logs 109 includes agent logged hours by a cost code, agent vacation and out of office (OOO) requests, and agent logged hours average acceleration by cost code. In aspects of the present invention, the third set of data from the HR system 111 includes agent contracted hours, an agent attrition indicator, an agent department, and an agent management level and/or chain.

In FIG. 7, the agent hierarchical bandwidth predictor module 165 receives the ticket input and predicts bandwidth hours by the department and the agent based on the ticket input data (as described in FIG. 5). The agent hierarchical bandwidth predictor module 165 sends the predicted bandwidth hours by the department and the agent to the resolution estimator module 160 (as described in FIG. 5). The lifecycle generator module 155 sends the similar lifecycles, the similar profiles, the identified ticket components, and the corresponding weightage for each ticket to the resolution estimator module 160.

The resolution estimator module 160 determines an estimated resolution time of the identified ticket components corresponding to the current ticket based on similar profiles and similar lifecycles corresponding to historical tickets. In an example, the resolution estimator module 160 determines similar profiles and similar lifecycles corresponding to historical tickets as the identified ticket components, extracts an actual resolution time within the similar profiles and the similar lifecycles of the historical tickets, and uses the extracted actual resolution time in determining the estimated resolution time of the identified ticket components.

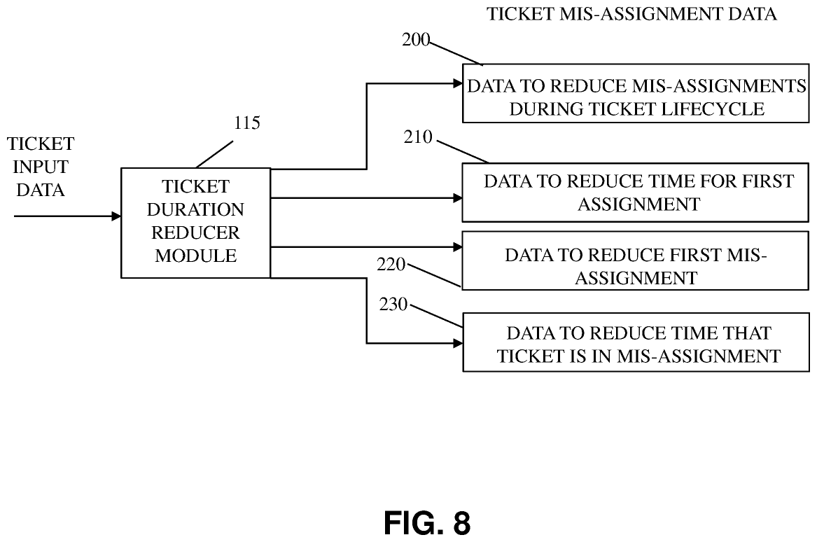

FIG. 8 shows a block diagram of a ticket duration reducer module 115 in accordance with aspects of the present invention. In FIG. 8, the ticket duration reducer module 115 receives the ticket input data and outputs the ticket mis-assignment data. In particular, the ticket mis-assignment data includes data to reduce mis-assignments during the ticket lifecycle 200, data to reduce time for first assignment 210, data to reduce first mis-assignment 220, and data to reduce time that ticket is in mis-assignment 230.

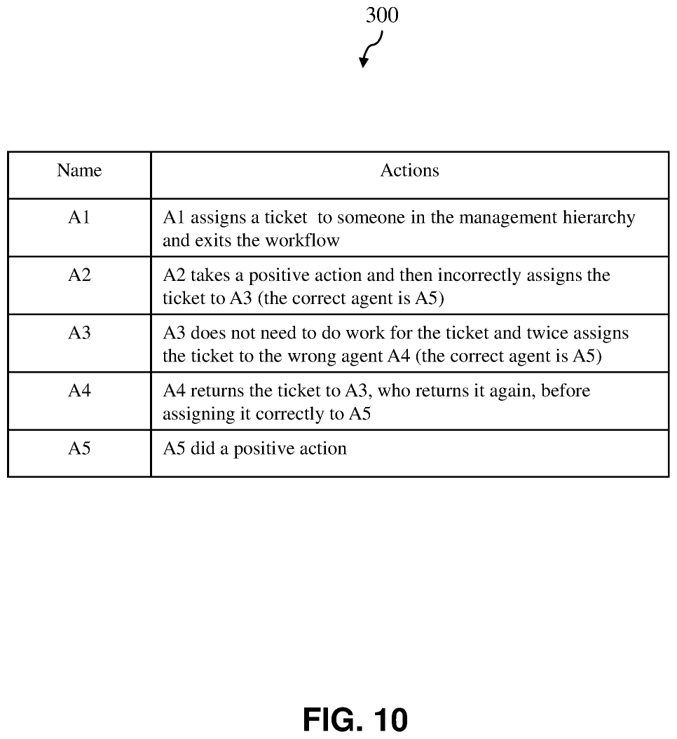

In FIG. 8, the ticket duration reducer module 115 outputs the data to reduce mis-assignments during the ticket lifecycle 200 by identifying an agent and a department as a culprit for mis-assignments using a network graph and a regression model, identifying a first mis-assignment in response to the first mis-assignment occurring, and assigning the current ticket to a same person in a department (as shown in FIG. 9). Further, the ticket duration reducer module 115 outputs the data to reduce time for first assignment 210 by automatically assigning tickets in response to the tickets entering a queue using a classification model, alerting a ticket stale state when a ticket is open too long with no action, alerting a slow response time for an agent or a department for providing retraining and identifying resource constraints (as shown in FIGS. 9 and 10). In further embodiments, the ticket duration reducer module 115 outputs the data to reduce a first mis-assignment 220 by creating a first assignment classification model and altering the classification model when retraining is needed (i.e., when data drift occurs). In aspects of the present invention, the ticket duration reducer module 115 outputs the data to reduce a time that a ticket is in mis-assignment 230 by identifying the culprit for stale tickets for an agent and a department, provide a real-time alert for stale tickets, and identifying vacation and/or attrition of an agent within a department (as shown in FIGS. 9 and 10). As shown in FIG. 4, the ticket duration reducer module 115 outputs the ticket mis-assignment data to the output module 120.

FIG. 9 shows an example of the ticket duration reducer module (such as ticket duration reducer module 115) modeling a network in accordance with aspects of the present invention. In particular, the ticket duration reducer module 115 identifies a culprit for a mis-assignment by modeling a network 250 for each ticket. In other words, modeling the network 250 for each ticket is used to determine a culprit to reduce mis-assignment time. In embodiments of the network 250 in FIG. 9, each node includes an agent name (e.g., A1, A2, A3, A4, and A5), a department (e.g., D1, D2, D3, and D4), and a level agent designation (e.g., Level 1, 2). In further embodiments of the network 250, the arrows designate a Boolean value (e.g., Action: 0=no positive action taken and Action: 1=positive action taken), duration in time (e.g., 1910 seconds), and sequence number (1, 2, 3, 4, 5, 6, 7, and 8) between nodes.

FIG. 10 shows an example of a table of actions of the ticket duration reducer module modeling the network of FIG. 9 in accordance with aspects of the present invention. In particular, the table 300 of FIG. 10 corresponds with the modeled network 250 in FIG. 9. Thus, the table 300 of FIG. 10 is also used to determine a culprit to reduce mis-assignment time.

In the table 300 of FIG. 10, the agent A1 assigns a ticket to someone in the management hierarchy (e.g., agent A2 in a same department D1) and exits the workflow (this is shown in the network 250 of FIG. 9 as (1) Action: 0 with Time: 1910 seconds). Further, in the table 300, the agent A2 takes a positive action (e.g., Action=1) and then incorrectly assigns the ticket to agent A3, even though the correct agent is agent A5 (this is shown in the network 250 of FIG. 9 as (4) Action: 1 Time: 2311 seconds). In embodiments of the table 300, the agent A3 does not need to do work for the ticket and twice assigns the ticket to the wrong agent A4, even though the correct agent is agent A5 (this is shown in the network 250 of FIG. 9 as (5) Action: 0 Time: 489 seconds). In embodiments of the table 300, the agent A4 returns the ticket to agent A3, who returns it again, before assigning it correctly to agent A5 (this is shown in the network 250 of FIG. 9 as (6) Action: 0 Time: 4985 seconds, (7) Action: 0 Time: 59 seconds, and (8) Action: 0 Time: 478 seconds). In further embodiments of the table 300, the agent A5 performs a positive action.

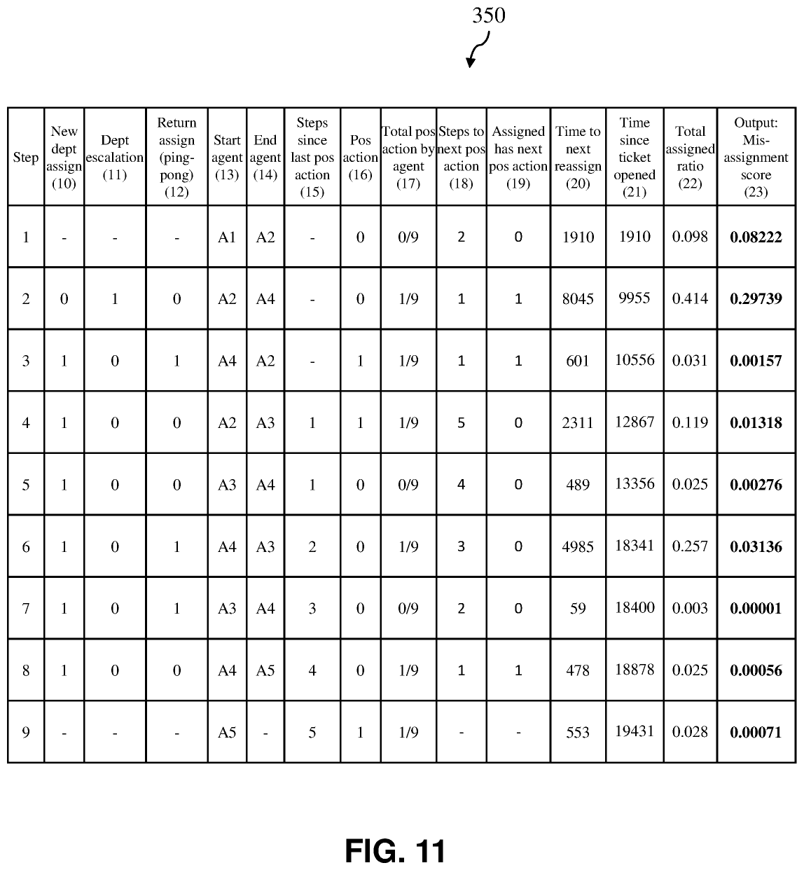

FIG. 11 shows a table for a regression model of the ticket duration reducer module in accordance with aspects of the present invention. In particular, the table 350 of FIG. 11 includes a plurality of steps 1-9, a new department assignment (10), a department escalation (11), a return assignment (12), a start agent (13), an end agent (14), steps since last positive action (15), positive action (16), total positive action by the agent (17), steps to the next positive action (18), assigned has next positive action (19), time to next re-assignment (20), time since ticket opened (21), total assigned ratio (22), and output mis-assignment score (23). In embodiments of the present invention, the ticket duration reducer module 115 uses these values of the table 350 to identify a mis-assignment culprit and calculate a mis-assignment score based on ML, such as a linear regression model with a feedback loop. In aspects of the present invention, the ticket duration reducer module 115 determines the ticket mis-assignment data based on the mis-assignment score. For example, for step 1, the mis-assignment score is 0.08222, which indicates a low probability of a mis-assignment occurring in this step. In contrast, for step 2, the mis-assignment score is 0.29739, which indicates a high probability of a mis-assignment occurring in this step. In embodiments of FIG. 11, the ticket duration reducer module 115 trains and builds the linear regression model by training labels. In further embodiments, the ticket duration reducer module 115 re-trains the linear regression model as new tickets are generated with a new series of inputs. In embodiments, the ticket duration reducer module 115 uses initial labeling as an input for the linear regression model. For example, the ticket duration reducer module 115 calculates the initial labeling by the following Formula 1:

$$Initial Labeling = Total Assigned Ratio * ( 1 - Total Positive Action by Agent ) * Sum ( Time to Next Re - Assignment for Each Step to Next Positive Action ) / Sum ( Time since Ticket Opened to Next Positive Action ) . \qquad ( Formula 1 )$$

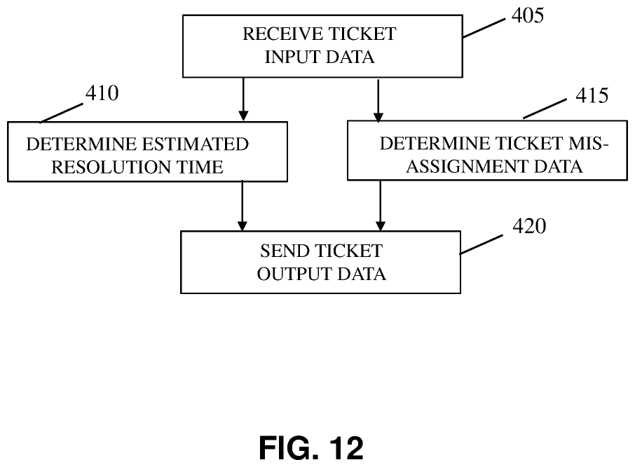

FIG. 12 shows a flowchart of an exemplary method in accordance with aspects of the present invention. Steps of the method may be carried out in the environment of FIG. 4 and are described with reference to elements depicted in FIGS. 4, 5, and 8.

At step 405, the system receives ticket input data. In embodiments and as described with respect to FIG. 4, the dynamic lifecycle generator module 110 and the ticket duration reducer module 115 receives the ticket input data.

At step 410, the system determines, at the dynamic lifecycle generator module 110, an estimated resolution time. In embodiments, and as described with respect to FIGS. 4 and 5, the dynamic lifecycle generator module 110 determines the estimated resolution time using at least one machine learning (ML) model based on similar lifecycles corresponding to historical tickets, similar profiles corresponding to historical tickets, identified ticket components and corresponding weightages of the received ticket input data, and predicted bandwidth hours by a department and an agent of the received ticket input data. At step 415, the system determines, at the ticket duration reducer module 115, ticket mis-assignment data. In embodiments, and as described with respect to FIGS. 4 and 8, the ticket duration reducer module 115 determines the ticket mis-assignment data by using a network graph and a regression model. At step 420, the system sends, by the output module 120, the ticket output data. In embodiments, and as described with respect to FIG. 4, the output module 120 sends the ticket output data to an external system based on the estimated resolution time and the ticket mis-assignment data

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving, by a computing device, ticket input data;
determining, by the computing device, an estimated resolution time using at least one machine learning (ML) model based on the received ticket input data;
determining, by the computing device, a ticket mis-assignment data based on the received ticket input data; and
sending, by the computing device, ticket output data based on the estimated resolution time and the ticket mis-assignment data.

2. The method of claim 1, wherein the determining the estimated resolution time based on the received ticket input data further comprises:
receiving, by the computing device, a severity of each ticket of the received ticket input data; and
identifying, by the computing device, ticket components using a multilabel classifier model of the received ticket input data.

3. The method of claim 2, wherein the multilabel classified model is trained using deep learning with an artificial neural network (ANN).

4. The method of claim 2, further comprising:
determining, by the computing device, similar profiles to the identified ticket components using a similarity matrix model for historical tickets; and
determining, by the computing device, similar lifecycles to the identified ticket components using a lifecycle model for historical lifecycles.

5. The method of claim 4, wherein the similarity matrix model is trained using a K-nearest neighbors (KNN) algorithm with co-sine similarity.

6. The method of claim 4, wherein the lifecycle model is trained using a K-nearest neighbors (KNN) algorithm with co-sine similarity.

7. The method of claim 4, further comprising predicting, by the computing device, bandwidth hours by a department and an agent based on the received ticket input data.

8. The method of claim 7, further comprising determining, by the computing device, the estimated resolution time based on the predicted bandwidth hours, the determined similar profiles, and the determined similar lifecycles.

9. The method of claim 1, wherein the determining ticket mis-assignment data based on the received ticket input data further comprises:
modeling, by the computing device, a network for each ticket of the received ticket input data; and
calculating, by the computing device, a mis-assignment score based on a linear regression model with a feedback loop of the modeled network.

10. The method of claim 9, further comprising determining, by the computing device, the ticket mis-assignment data based on the mis-assignment score.

11. The method of claim 9, wherein the modeling the network for each ticket of the ticket input data further comprises modeling the network using a network graph which comprises at least two labeled nodes and at least one connection which connects each node together of the at least two labeled nodes together.

12. A computer program product comprising one or more computer readable storage media having program instructions collectively stored on the one or more computer readable storage media, the program instructions executable to:
receive ticket input data;
determine an estimated resolution time using at least one machine learning (ML) model based on the received ticket input data;
determine a ticket mis-assignment data based on the received ticket input data;
send a ticket output data based on the estimated resolution time and the ticket mis-assignment data; and
identify at least one culprit for the ticket mis-assignment data.

13. The computer program product of claim 12, wherein the determining the estimated resolution time based on the received ticket input data further comprises:
receiving a severity of each ticket of the received ticket input data; and
identifying ticket components using a multilabel classifier model of the received ticket input data.

14. The computer program product of claim 13, wherein the multilabel classified model is trained using deep learning with an artificial neural network (ANN).

15. The computer program product of claim 13, further comprising:
determining similar profiles to the identified ticket components using a similarity matrix model for historical tickets; and
determining similar lifecycles to the identified ticket components using a lifecycle model for historical lifecycles.

16. The computer program product of claim 15, wherein the similarity matrix model is trained using a K-nearest neighbors (KNN) algorithm with co-sine similarity.

17. The computer program product of claim 15, wherein the lifecycle model is trained using a K-nearest neighbors (KNN) algorithm with co-sine similarity.

18. The computer program product of claim 12, further comprising predicting bandwidth hours by a department and an agent based on the received ticket input data.

19. The computer program product of claim 12, wherein the determining ticket mis-assignment data based on the received ticket input data further comprises:
modeling a network for each ticket of the ticket input data; and
calculating a mis-assignment score based on a linear regression model with a feedback loop of the modeled network.

20. A system comprising:
a processor, a computer readable memory, one or more computer readable storage media, and program instructions collectively stored on the one or more computer readable storage media, the program instructions executable to:
receive ticket input data;
predict bandwidth hours by a department and an agent based on the received ticket input data;
determine an estimated resolution time using at least one machine learning (ML) model based on the received ticket input data and the predicted bandwidth hours;
determine a ticket mis-assignment data based on the received ticket input data; and
send a ticket output data based on the estimated resolution time and the ticket mis-assignment data.
